(19) United States
(12) Patent Application Publication
(10) Pub. No.: US 2020/0042156 A1
(43) Pub. Date: Feb. 6, 2020

(54) INTERACTIVE MULTI-VALUE ROTATIONAL OBJECT

(71) Applicant: SAP SE, Walldorf (DE)

(72) Inventors: Tim Philipp Trabold, Reilingen (DE); Udo Klein, Nussloch (DE)

(21) Appl. No.: 16/051,548

(22) Filed: Aug. 1, 2018

(51) Int. Cl. G06F 3/0481; G06F 17/30

(52) U.S. Cl. CPC G06F 3/04815; G06F 17/30539; G06F 17/30607; G06F 17/30554; G06F 17/30572; G06F 17/30595

(57) ABSTRACT

Provided are systems and methods which generate and display an three-dimensional (3D) object representing multiple values. Rotation of the object provides different views of the values enabling easier understanding of the differences. In one example, the method may include receiving a first dataset and a second dataset, identifying a value from the first dataset and a value from the second dataset which are associated with each other, generating a rotational three-dimensional (3D) object comprising a first component having a size representing the value from the first dataset and a second component having a size representing the value from the second dataset value, and outputting the rotational 3D object via a user interface where the rotational 3D object is configured to display different rotational views of the first and second component.

### BACKGROUND

Tables are used to organize and store information in a structured format. Tables typically include horizontal rows and vertical columns which overlap to produce an array of cells. Often the rows and columns are named so as to describe the data included therein. Tables are commonly used in areas such as communication, research, analytics, and data storage. Due to their structured format, tables are commonly used to store data in a database (e.g., relational databases, file database, etc.) Tables are also used in spreadsheets and other files to provide viewers with an organized and compact view of related data. More sophisticated tables may further include metadata, headers, footers, annotations, and the like.

However, one of the drawbacks of a table is the density at which data is stored. The density inhibits understanding of the data or its purpose, and may require a significant amount of time for reading through the data, glancing at the headings, and possibly doing additional calculations. Another drawback is the difficulty in comparing data from two different tables. In this scenario, the user must read data from different tables (rows/columns), correlate the data, and determine how the data compares. This can be a difficult task especially for tables that may include hundreds, thousands, or even millions of values. In some cases, a user may need to read data one cell at a time to acquire and understand information from the table. Furthermore, the user may not understand a relationship between different cells of data in the table without reading the data values from most or all of the cells.

### BRIEF DESCRIPTION OF THE DRAWINGS

Features and advantages of the example embodiments, and the manner in which the same are accomplished, will become more readily apparent with reference to the following detailed description while taken in conjunction with the accompanying drawings. The application file contains at least one drawing that is executed in color. Copies of this patent or patent application publication with the color drawings will be provided by the Office upon request and payment of the necessary fee.

FIG. 1 is a diagram illustrating a database system architecture in accordance with an example embodiment.

FIGS. 2A-2C are diagrams illustrating views of a rotational 3D object in accordance with an example embodiment.

FIGS. 3A-3C are diagrams illustrating views of a rotational 3D object in accordance with another example embodiment.

FIGS. 4A-4B are diagrams illustrating a table including an array of rotational 3D objects in accordance with example embodiments.

FIG. 5 is a diagram illustrating a method for generating a multi-value three-dimensional rotational object in accordance with an example embodiment.

FIG. 6 is a diagram illustrating a computing system in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a system which generates three-dimensional (3D) objects having multiple sub-components capable of representing data from multiple datasets. In some embodiments, the 3D object may be a rotational object which provides angular views of the sub-components of the 3D object enabling easy comparisons of two data values represented by the two sub-components. For example, the 3D object may include a first component representing a first data value of a first dataset and a second component representing a second data value of a second data set. Each of the first component and the second component may have sizes that are dependent on respective sizes of the first and second data values.

The 3D object including the first and second components can be rotated about an axis of rotation within a user interface providing a viewer with a better visualization of the first and second components with respect to each other. The rotation enables an easy understanding of the differences in value between the first data value and the second data value. For example, the 3D object may include a side view in which sides of the respective first and second components are shown together. As another example, the 3D object may be toggled causing a rotation of the 3D object moving the first component in front of the second component, and vice versa, enabling an overlapping view of the first and second components for quickly discerning the differences in values between the two components. In some embodiments, the 3D object may be incorporated into a table/chart with many 3D objects enabling two larger datasets to be quickly and visually compared to one another in a single table.

Conventional visualizations of chart data such as activity charts provide a measure of activity records. Most commonly, an activity chart pairs date (e.g., in the form of a day, week, etc.) versus time (e.g., hour, minute, etc.) and dots or plots representing activities performed are shown with differing intensities (sizes) to indicate how many events occurred at a specific time, on a specific day, etc. For example, an activity chart may include a two-dimensional array of dots having different intensities representing a dataset. In some cases, the diameter of the dots in the chart may be used to represent the intensity while the location of the dots on the horizontal axis may represent the point in time. While this visualization may provide a quick overview on the overall activity over time, it is not efficient for understanding a relationship between two different datasets. To do so would require two separate charts (one for each dataset). Comparing two charts can be difficult due to limited screen-sizes, long distance between the data-points being compared, different scale of the graphs, and the like. The example embodiments overcome these drawbacks by incorporating two data values (e.g., from two datasets) into a single 3D object (and a single chart), and providing multiple views of the 3D object enabling a viewer to compare the two data values in a user-friendly manner.

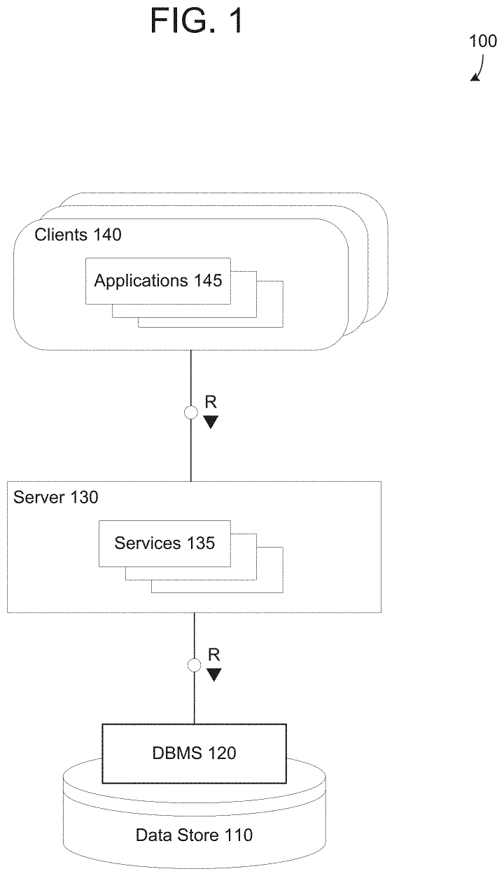

FIG. 1 illustrates a system architecture of a database 100 in accordance with an example embodiment. It should be appreciated that the embodiments are not limited to architecture 100 or to a database architecture, however, FIG. 1 is shown for purposes of example. Referring to FIG. 1, the architecture 100 includes a data store 110, a database management system (DBMS) 120, a server 130, services 135, clients 140 and applications 145. Generally, services 135 executing within server 130 receive requests from applications 145 executing on clients 140 and provides results to applications 145 based on data stored within data store 110. For example, server 130 may execute and provide services 135 to applications 145. Services 135 may comprise server-side executable program code (e.g., compiled code, scripts, etc.) which provide functionality to applications 145 by providing user interfaces to clients 140, receiving requests from applications 145 (e.g., drag-and-drop operations), retrieving data from data store 110 based on the requests, processing the data received from data store 110, and providing the processed data to applications 145.

In one non-limiting example, a client 140 may execute an application 145 to perform visual analysis of analytical data or chart-based data causing 3D object data to be output to a user interface on a display of the client 140 which allows the user to view analytical information such as charts, graphs, tables, and the like, based on the underlying data stored in the data store 110. The application 145 may pass analytic information based on the input to one of services 135. A structured query language (SQL) script may be generated based on the request and forwarded to DBMS 120. DBMS 120 may execute the SQL script to return a result set based on data of data store 110, and the application 145 creates a report/visualization based on the result set. As another example, the analytic data may be input by the user and provided directly from the application 145 to the DBMS 120 or the data store 110. According to various embodiments, an application 145 may include the logical components to perform the data merge and conflict resolution steps/processes described herein.

The services 135 executing on server 130 may communicate with DBMS 120 using database management interfaces such as, but not limited to, Open Database Connectivity (ODBC) and Java Database Connectivity (JDBC) interfaces. These types of services 135 may use SQL to manage and query data stored in data store 110. The DBMS 125 serves requests to query, retrieve, create, modify (update), and/or delete data from database files stored in data store 110, and also performs administrative and management functions. Such functions may include snapshot and backup management, indexing, optimization, garbage collection, and/or any other database functions that are or become known.

Server 130 may be separated from or closely integrated with DBMS 120. A closely-integrated server 130 may enable execution of services 135 completely on the database platform, without the need for an additional server. For example, server 130 may provide a comprehensive set of embedded services which provide end-to-end support for Web-based applications. The services 135 may include a lightweight web server, configurable support for Open Data Protocol, server-side JavaScript execution and access to SQL and SQLScript. Server 130 may provide application services (e.g., via functional libraries) using services 135 that manage and query the database files stored in the data store 110. The application services can be used to expose the database data model, with its tables, views and database procedures, to clients 140. In addition to exposing the data model, server 130 may host system services such as a search service.

Data store 110 may comprise any query-responsive data source or sources that are or become known, including but not limited to a SQL relational database management system. Data store 110 may include or otherwise be associated with a relational database, a multi-dimensional database, an Extensible Markup Language (XML) document, or any other data storage system storing structured and/or unstructured data. The data of data store 110 may be distributed among several relational databases, dimensional databases, and/or other data sources. Embodiments are not limited to any number or types of data sources. In some embodiments, the data of data store 110 may include files having one or more of conventional tabular data, row-based data, column-based data, object-based data, and the like. Moreover, the data may be indexed and/or selectively replicated in an index to allow fast searching and retrieval thereof. Data store 110 may support multi-tenancy to separately support multiple unrelated clients by providing multiple logical database systems which are programmatically isolated from one another. Furthermore, data store 110 may support multiple users that are associated with the same client and that share access to common database files stored in the data store 110.

The architecture 100 may include metadata defining objects which are mapped to logical entities of data store 110. The metadata may be stored in data store 110 and/or a separate repository (not shown). The metadata may include information regarding dimension names (e.g., country, year, product, etc.), dimension hierarchies (e.g., country, state, city, etc.), measure names (e.g., profit, units, sales, etc.) and any other suitable metadata. According to some embodiments, the metadata includes information associating users, queries, query patterns and visualizations. The information may be collected during operation of system and may be used to determine a visualization to present in response to a received query, and based on the query and the user from whom the query was received.

Each of clients 140 may include one or more devices executing program code of an application 145 for presenting user interfaces to allow interaction with application server 130. The user interfaces of applications 145 may comprise user interfaces suited for reporting, data analysis, and/or any other functions based on the data of data store 110. Presentation of a user interface as described herein may include any degree or type of rendering, depending on the type of user interface code generated by server 130. For example, a client 140 may execute a Web Browser to request and receive a Web page (e.g., in HTML format) from application server 130 via HTTP, HTTPS, and/or WebSocket, and may render and present the Web page according to known protocols.

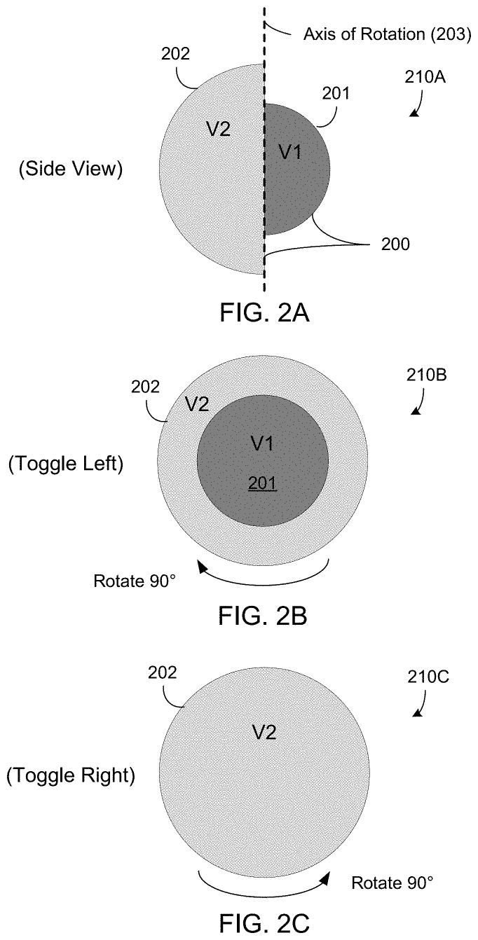

One or more of clients 140 may also or alternatively present user interfaces by executing a standalone executable file (e.g., an .exe file) or code (e.g., a JAVA applet) within a virtual machine. Clients 140 may execute applications 145 which perform merge operations of underlying data files stored in data store 120. Furthermore, clients 140 may execute the conflict resolution methods and processes described herein to resolve data conflicts between different versions of a data file stored in the data store 110. A user interface may be used to display rotational 3D objects as described or shown in the examples of FIGS. 2A-2C, 3A-3C, 4A-4B, and the like. In some embodiments, the rotational 3D objects may be included in a chart or table with other rotational 3D objects such as when comparing two datasets to one another.

FIGS. 2A-2C illustrate views 210A-210C of a rotational 3D object 200 in accordance with an example embodiment. Referring to FIGS. 2A-2C, the rotational 3D object 200 includes a first component 201 (green) representing a first data value and a second component 202 (red) representing a second data value. The first and second data values may be from different datasets or the same dataset. The first and second components 201 and 202 each include 3D objects that are in the shape of a hemisphere, however, embodiments are not limited thereto. As another example, the component shapes may include a square block, a rectangular block, a cylinder, a cone, a triangle, a tube, an unstructured object, a design, or more than one 3D shape combined together. Also, in the examples of FIGS. 2A-2C the first and second components 201 and 202 are touching each other (contact) but embodiments are not limited thereto.

As mentioned, the first component 201 includes a hemisphere shape or a half spherical shape while the second component 202 includes a corresponding hemisphere shape that is a mirror-image of the hemisphere shape of the first component 201. The first component 201 represents a first numerical value V1 that may be obtained from a first dataset while the second component 202 represents a second numerical value V2 that may be obtained from a second dataset. The size of the first component 201 is used to represent a size of the corresponding numerical value V1 and a size of the second component 202 is used to represent a size of the corresponding numerical value V2. Here, the numerical value may be represented by the volume, diameter, height, width, and/or the like, of the visual component object which can be a three-dimensional sub-object of the rotational 3D object. In this case, the second component 202 is larger in size (volume and diameter) than the first component 201 thereby visually indicating that the numerical value V2 is greater than the numerical value V1.

Referring to FIG. 2A, a side view 210A of the rotational 3D object 200 is shown whereas in FIGS. 2B and 2C the rotational 3D object 200 is turned/rotated creating different rotational views 210B and 210C. The rotational 3D object 200 is rotated about a vertical axis 203 with respect to the side view 210A shown in FIG. 2A. In the side view 210A, both the first and second components 201 and 202 are shown from corresponding side angle views. The side view 210A may be a default or initial view of the 3D object 200, however, embodiments are not limited thereto. It should be appreciated that any of the views 210A-210C (or other views not shown) may be default views. Through the side view 210A, it can be ascertained that the first component 201 is a mirrored shape of the second component 202.

Meanwhile, a toggle input may be received from the user via an input device such as a touch on a touch screen, a spoken command, a hand gesture, an eye movement, mouse, a keyboard, or some other form of input. Different toggle commands may be used to rotate the rotational 3D object 200 in different directions. For example, a first input which may be predefined may cause the rotational 3D object 200 to rotate in a first direction (i.e., towards the left as shown in view 210B of FIG. 2B) while a second input which may also be predefined may cause the rotational 3D object 200 to rotate in a second direction (i.e., towards the right as shown in view 210C of FIG. 2C). As a non-limiting example, selecting a right button on a mouse may cause the rotational 3D object 200 to rotate towards the right while a left button on the mouse may cause the rotational 3D object 200 to the right, however, different inputs may be received.

When the rotational 3D object 200 is rotated 90° about the axis of rotation 203 in the example of FIG. 2B, the first component 201 moves in front of the second component 202 on the user interface based on the rotation about the axis of rotation 203. As a result, the first component 210 partially obscures (i.e., a center portion) of the second component 202 in the view 210B as a result of the different sizes of the first and second components 201 and 202. Based on this view 210B, it can be readily ascertained that V1 is smaller than V2 based on parts of red from the second component 202 being visible and not being completely obscured by the first component 201. Furthermore, it can also be readily ascertained how much bigger V2 is than V1 based on a very quick glance of how much of the second component 202 is obscured by the first component 201 making the understanding easy for the viewer. When the rotational 3D object 200 is rotated 90° about the axis of rotation 203 in a different direction (opposite) in FIG. 2C, the second component 202 moves in front of the first component 201 within the view 210C of the user interface based on the axis of rotation 203. Here, the second component 202 completely obscures the first component 201 which indicates that V2 is larger than V1.

The views 210A-210C of FIGS. 2A-2C may be shown via a user interface on a screen of a computing device such as a monitor, a television, a mobile device, a tablet, a gaming console, and the like. In the examples of FIGS. 2A-2C, it can be easy to comprehend that the value V1 is smaller than the value V2 given that the size of the first component 201 shown in green is smaller than the size of the second component 202 shown in red. The differing colors may be chosen so as to clearly contrast with one another rather than using different shades of grey and/or black and white. In the example of FIGS. 2A-2C, the rotational 3D object 200 may be rotated about a vertical axis of rotation 203 (e.g., the Y axis). It should also be appreciated that, although not shown, the axis of rotation may be the horizontal axis (e.g., the X axis).

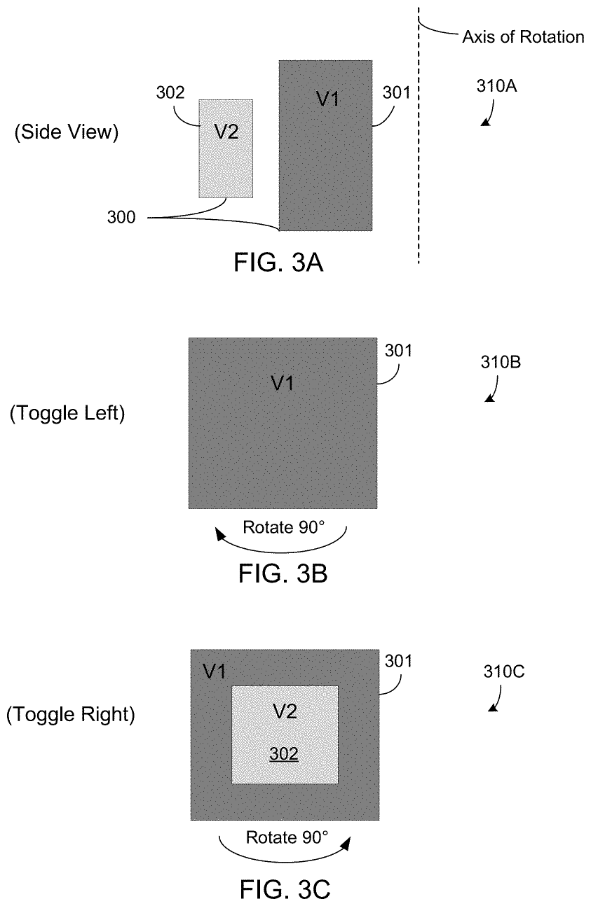

FIGS. 3A-3C illustrate views 310A-310C of a rotational 3D object 300 in accordance with another example embodiment. In these examples, the rotational 3D object 300 includes a first component 301 (blue) and a second component 302 (orange) which are each in the shape of a rectangular block. Furthermore, in the examples of FIGS. 3A-3C, the first component 301 and the second component 302 are not in contact but rather spaced apart by a distance therebetween. Another difference with the examples of FIGS. 3A-3C with respect to FIGS. 2A-2C is that an axis of rotation 303 is positioned on the outside of and to the right of the first component 301 such that the first component 301 is between the axis of rotation 303 and the second component 302. Here, the first component 301 and the second component 302 may move horizontally when rotated because of a position of the axis of rotation 303. In the examples of FIGS. 3A-3C, the first component 301 represents a numerical value V1 and the second component 302 represents a numerical value V2 where V2 is smaller than V1. Accordingly, a size of the first component 301 representing V1 is greater in size than the second component 302 representing V2.

An initial view 310A in FIG. 3A illustrates a side view of the first and second components 301 and 302. Meanwhile, FIG. 3B illustrates a first rotated view 310B in which the first and second components 301 and 302 are rotated 90° about the axis of rotation 303 in unison causing the first component 301 to move in front of the second component 302 within a view of the user interface. In addition, FIG. 3C illustrates a second rotated view 310C in which the first and second components are rotated 90° about the axis of rotation 303 with respect to the initial view 310A causing the second component 302 to move in front of the first component 301 on the screen. The rotation causes the second component 302 to obscure (partially) the first component 301 on the screen. Based on the toggling rotation of the rotational 3D object 300, it can be readily ascertained that the first component 301 is larger than the second component 302 and that the numerical value V1 is larger than the numerical value V2.

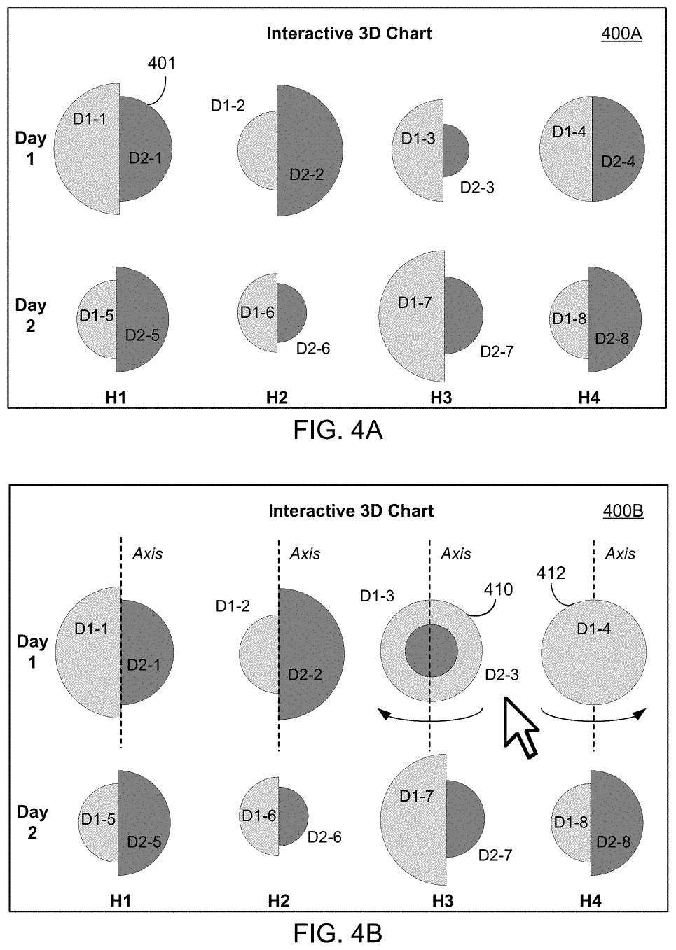

FIGS. 4A-4B illustrate a table chart with a plurality of views 400A and 400B of an array of rotational 3D objects in accordance with example embodiments. Here, the table chart includes a plurality of rotational 3D objects which are arranged in a two-dimensional array in a plurality of rows and a plurality of columns. The table represents days on the vertical axis, hours on the horizontal axis, and an intensity of an activity (or other value) with the rotational 3D objects. Here, each object includes two component representing values from two datasets D1 and D2. Each value is represented by a hyphenated number. For example, the first value of the first dataset is represented by D1-1, the second value of the first dataset is represented by D1-2, and so forth. An example of two datasets are shown below. In particular Table 1 and Table 2 correspond to the first dataset and the second dataset, respectively. While the hours and the days correspond to the headings of the table. Here, the datasets have values ranging from 20 to 90.

TABLE 1

| | Day 1 | Day 2 |
|---|---|---|
| Hour 1 | D1-1 = 90 | D1-2 = 40 |
| Hour 2 | D1-3 = 70 | D1-4 = 80 |
| Hour 3 | D1-5 = 30 | D1-6 = 20 |
| Hour 4 | D1-7 = 90 | D1-8 = 30 |

TABLE 2

| | Day 1 | Day 2 |
|---|---|---|
| Hour 1 | D2-1 = 70 | D2-2 = 90 |
| Hour 2 | D2-3 = 20 | D2-4 = 80 |
| Hour 3 | D2-5 = 80 | D2-6 = 30 |
| Hour 4 | D2-7 = 50 | D2-8 = 70 |

According to various embodiments, the values within Table 1 and Table 2 may be correlated with one another (or otherwise associated) by the system. For example, value D1-1 may be associated with value D2-1 by the system as corresponding to the same hour of the same day. Likewise, value D1-2 may be associated with value D2-2, and the so forth. Referring to the table charts in FIGS. 4A-4B, the values from dataset D1 are represented by the left component (grey) of the rotational 3D objects while the values from the dataset D2 are represented by the right component (yellow) of the rotational objects as shown in the view 400A of the table. The first view 400A of the table includes each of the rotational objects biased on a side view displaying side views of both the left component (grey) and the right component (yellow).

In the example of FIG. 4B, a view 410B of the table chart is shown in which the system has detected/received multiple inputs (toggles) causing rotation of rotational 3D objects 410 and 412 as shown. In particular, rotational 3D object 410 has been rotated to the left based on a toggle input while the rotational 3D object 412 has been rotated to the right based on a second toggle input. The table of rotational 3D objects is interactive in that each rotational 3D object can be independently and separately interacted with (rotated) to reveal additional views of the respective rotational 3D object. Each of the rotational 3D objects have a common axis of rotation such that when toggled, the rotational 3D objects move around the axis.

In these examples, the axis of rotation is shown as a vertical axis only for ease of description. It should also be understood that the axis of rotation may be a horizontal axis in which the 3D object rights towards and away from the viewer around the horizontal axis instead of the vertical axis.

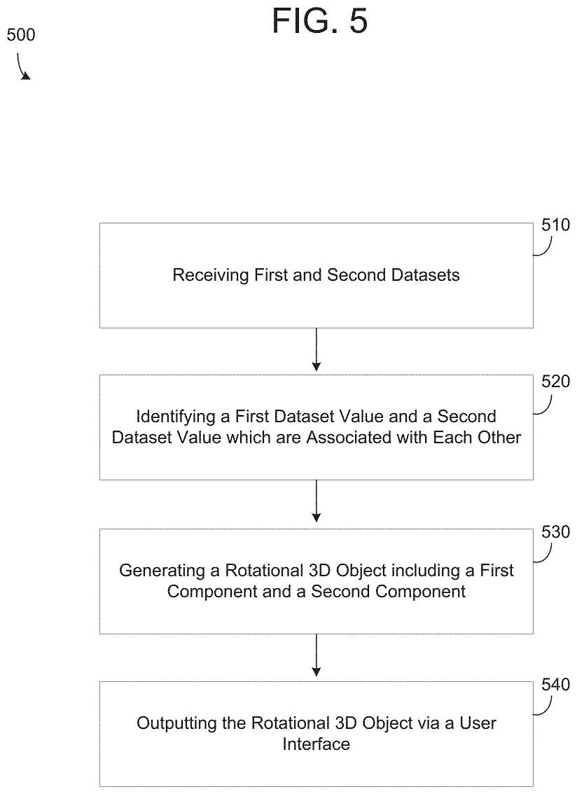

FIG. 5 illustrates a method 500 for in accordance with an example embodiment. As an example, the method 500 may be performed by a database node included within a distributed database system. As another example, the method 500 may be performed by a computing device such as a server, a cloud platform, a user device, an on-premises server, and the like. In some examples, the method 500 may be performed by a plurality of devices in combination. Referring to FIG. 5, in 510, the method may include receiving a first dataset and a second dataset. As a non-limiting example, the datasets may include time-based event or activity data, however, embodiments are not limited thereto. The values within the datasets may include numerical values that can be compared with each other.

The datasets may include tabular data such as row(s) and/or column(s) of data with values therein and headings on each of the rows and/or columns. The first dataset and the second dataset may include values that are associated with one another. In 520, the method may include identifying a first dataset value from the first dataset and a second dataset value from the second dataset which are associated with each other. The system may identify values that are to be compared with one another based on headings of the rows and/or columns of data, or the like.

In 530, the method may include generating a rotational 3D object including a first component having a size representing the first dataset value and a second component having a size representing the second dataset value, and in 540, outputting the rotational 3D object via a user interface where the rotational 3D object is configured to display different rotational views of the first and second component. The first component and second components may 3D objects having a shape and/or a size that represents a numerical value of the first and second dataset values, respectively. The first and second components may be combined to generate the 3D rotational object. For example, in response to the first dataset value being less than the second dataset value, the generating may include generating the first component such that it is smaller in size than the second component.

An axis of rotation of the rotational 3D object may be positioned between the first and second components. As another example, the axis of rotation may be positioned behind both the first and second components, or the like. In some embodiments, the first component may be a mirrored shape of a shape of the second component, and the first and second components may rotate about the axis of rotation while facing each other. In some embodiments, the first component and the second component may be corresponding halves of a whole 3D shape. The rotational 3D object may be rotated to provide different views of the 3D object which reveal different views of the first and second components with respect to each other.

In one example, an initial view of the rotational 3D object may include side views of the first and second components. A toggle command may be detected via the user interface. In response, the system may rotate the rotational 3D object in either direction. For example, a rotation of the rotational 3D object in a first direction displays the first component in front of and at least partially obscuring the second component, and a rotation of the rotational 3D object in a second direction displays the second component in front of and at least partially obscuring the first component.

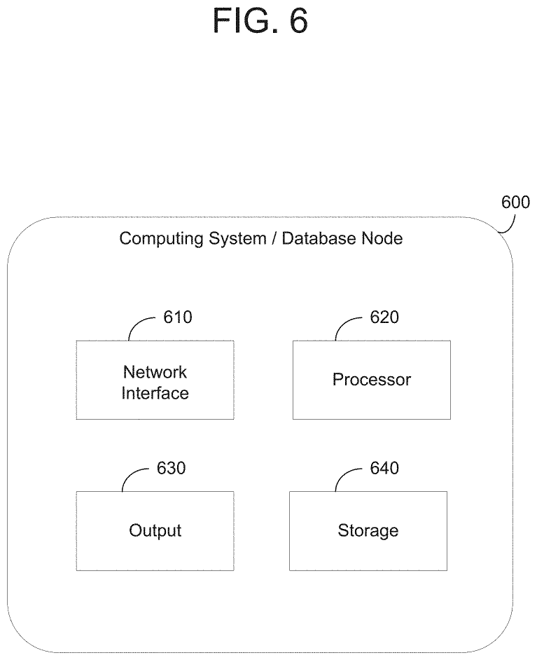

FIG. 6 illustrates a computing system 600, in accordance with an example embodiment. For example, the computing system 600 may be a database node, a server, a cloud platform, a user device, or the like. In some embodiments, the computing system 600 may be distributed across multiple devices. Referring to FIG. 6, the computing system 600 includes a network interface 610, a processor 620, an output 630, and a storage device 640 such as an in-memory. Although not shown in FIG. 6, the computing system 600 may also include or be electronically connected to other components such as a display, an input unit, a receiver, a transmitter, a persistent disk, and the like. The processor 620 may control the other components of the computing system 600.

The network interface 610 may transmit and receive data over a network such as the Internet, a private network, a public network, an enterprise network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The output 630 may output data to an embedded display of the computing system 600, an externally connected display, a display connected to the cloud, another device, and the like. For example, the output 630 may include a port, an interface, a cable, a wire, a board, and/or the like, with input/output capabilities. The network interface 610, the output 630, or a combination thereof, may interact with applications executing on other devices. The storage device 640 is not limited to a particular storage device and may include any known memory device such as RAM, ROM, hard disk, and the like, and may or may not be included within the cloud environment. The storage 640 may store software modules or other instructions which can be executed by the processor 620 to perform the method 500 shown in FIG. 5.

According to various embodiments, the processor 620 may receive a first dataset and a second dataset, identify a first dataset value from the first dataset and a second dataset value from the second dataset which are associated with each other, and generate a rotational three-dimensional (3D) object comprising a first component having a size representing the first dataset value and a second component having a size representing the second dataset value. In response, the output 630 may output the rotational 3D object via a user interface where the rotational 3D object is configured to display different rotational views of the first and second component. The rotational 3D object may be rotated about an axis of rotation which may be positioned between the first and second components, but embodiments are not limited thereto. In some embodiments, the processor 620 may receive a toggle input via the user interface and, in response, rotate the rotational 3D object a predetermined amount.

In some embodiments, the first component may include a mirrored shape of a shape of the second component of the rotational 3D object, and the processor 620 may rotate the first and second components about the axis of rotation while facing each other. In some embodiments, the first component and the second component may each include corresponding halves of a whole 3D shape. In response to the first dataset value being less than the second dataset value, the processor 620 may generate the first component such that it is smaller in size than the second component. In some embodiments, an initial view of the rotational 3D object output by the processor 620 via the output 630 may include respective side views of the first and second components. In this example, the processor 620 may rotate the rotational 3D object in a first direction the user interface displays the first component in front of and at least partially obscuring the second component, and the processor 620 may rotate the rotational 3D object in a second direction the user interface displays the second component in front of and at least partially obscuring the first component.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

1. A computing system comprising:
a processor configured to receive a first dataset and a second dataset, identify a value from the first dataset and a value from the second dataset which are associated with each other, and generate a rotational three-dimensional (3D) object comprising a first component having a size representing the value from the first dataset and a second component having a size representing the value from the second dataset value; and
an output configured to output the rotational 3D object via a user interface,
wherein the processor is configured to spin the rotational 3D object about a stationary axis of rotation between the first and second components thereby creating different two-dimensional views of a contrast in size between the first and second components.

2. The computing system of claim 1, wherein an interior of the first component is in contact with an interior of the second component at a position of the stationary axis of rotation of the rotational 3D object.

3. The computing system of claim 2, wherein the first component comprises a mirrored shape of a shape of the second component, and the processor rotates the mirrored-shaped first and second components about the stationary axis of rotation while facing each other.

4. The computing system of claim 1, wherein the processor is further configured to receive a toggle input via the user interface and, in response, rotate the rotational 3D object thereby creating a two-dimensional view in which a center of an outline of the second component is obscured by an outline of the first component.

5. The computing system of claim 1, wherein the first component and the second component each comprise opposing shaped hemispheres.

6. The computing system of claim 1, wherein, in response to the value from the first dataset being less than the value from the second dataset, the processor generates the first component such that it is smaller in size than the second component.

7. The computing system of claim 1, wherein an initial view of the rotational 3D object output by the processor comprises respective side views of the first and second components.

8. The computing system of claim 7, wherein when the processor rotates the rotational 3D object in a first direction the user interface displays the first component in front of and at least partially obscuring the second component, and when the processor rotates the rotational 3D object in a second direction the user interface displays the second component in front of and at least partially obscuring the first component.

9. A method comprising:
receiving a first dataset and a second dataset;
identifying a value from the first dataset and a value from the second dataset which are associated with each other;
generating a rotational three-dimensional (3D) object comprising a first component having a size representing the value from the first dataset and a second component having a size representing the value from the second dataset;
outputting the rotational 3D object via a user interface; and
spinning the rotational 3D object about a stationary axis of rotation between the first and second components thereby creating different two-dimensional views of a contrast in size between the first and second components with respect to each other.

10. The method of claim 9, wherein an interior of the first component is in contact with an interior of the second component at a position of the stationary axis of rotation of the rotational 3D object.

11. The method of claim 10, wherein the first component comprises a mirrored shape of a shape of the second component, and the mirrored-shaped first and second components rotate about the stationary axis of rotation while facing each other.

12. The method of claim 9, further comprising receiving a toggle input via the user interface and, in response, rotating the rotational 3D object thereby creating a two-dimensional view in which a center of an outline of the second component is obscured by an outline of the first component.

13. The method of claim 9, wherein the first component and the second component each comprise opposing shaped hemispheres.

14. The method of claim 9, wherein, in response to the value from the first dataset being less than the value from the second dataset, the generating comprises generating the first component such that it is smaller in size than the second component.

15. The method of claim 9, wherein an initial view of the rotational 3D object displays respective side views of the first and second components.

16. The method of claim 15, wherein a rotation of the rotational 3D object in a first direction displays the first component in front of and at least partially obscuring the second component, and a rotation of the rotational 3D object in a second direction displays the second component in front of and at least partially obscuring the first component.

17. A non-transitory computer-readable storage medium storing program instructions that when executed cause a processor to perform a method comprising:
receiving a first dataset and a second dataset;
identifying a value from the first dataset and a value from the second dataset which are associated with each other;
generating a rotational three-dimensional (3D) object comprising a first component having a size representing the value from the first dataset and a second component having a size representing the value from the second dataset;
outputting the rotational 3D object via a user interface; and
spinning the rotational 3D object about a stationary axis of rotation between the first and second components thereby creating different two-dimensional views of a contrast in size between the first and second components with respect to each other.

18. The non-transitory computer readable medium of claim 17, wherein an interior of the first component is in contact with an interior of the second component at a position of the stationary axis of rotation of the rotational 3D object.

19. The non-transitory computer readable medium of claim 18, wherein the first component comprises a mirrored shape of a shape of the second component, and the mirrored-shaped first and second components rotate about the stationary axis of rotation while facing each other.

20. The non-transitory computer readable medium of claim 17, wherein the method further comprises receiving a toggle input via the user interface and, in response, rotating the rotational 3D object thereby creating a two-dimensional view in which a center of an outline of the second component is obscured by an outline of the first component.

21. The computing system of claim 1, wherein the two-dimensional views include an overlapping view in which a two-dimensional image of the first component obscures a two-dimensional image of the second component.
